(19) United States
(12) Patent Application Publication
(10) Pub. No.: US 2013/0069325 A1
(43) Pub. Date: Mar. 21, 2013

(54) CASTOR WHEEL ASSEMBLY

(71) Applicant: Desmond John Wallace, Queensland (AU)

(72) Inventor: Desmond John Wallace, Queensland (AU)

(73) Assignee: Noah No. 1 Pty Ltd

(21) Appl. No.: 13/594,496

(22) Filed: Aug. 24, 2012

(30) Foreign Application Priority Data
Aug. 25, 2011 (AU) 2011903409

(51) Int. Cl. B60B 33/00; B62B 3/00

(52) U.S. Cl. CPC B60B 33/0002; B62B 3/00
USPC 280/47.34; 16/35 R

(57) ABSTRACT

Described herein are castor (a.k.a. caster) wheel assemblies, as well as devices (such as shopping trolleys or carts) that incorporate castor wheel assemblies.

### REFERENCE TO RELATED APPLICATION

This application claims the benefit of the earlier filing of Australia application number 2011903409, filed Aug. 25, 2011; the entire content of that application is incorporated herein by reference.

### TECHNICAL FIELD

The present disclosure relates to a castor wheel assembly. The present disclosure also relates to shopping trolleys that incorporate castor wheel assemblies.

### BACKGROUND

Castor wheels are used on various devices such as office chairs, shopping trolleys and as the light plane tailwheel for example. A castor wheel is a particular type of wheel that has a pivot mounting that is offset from the wheel axle. This causes the wheel to pivot about the pivot mounting to align itself generally with the direction in which a force is applied to the castor wheel. Castor wheels are used for office chairs, shopping trolleys and the like because their pivoting action enables these devices to be highly manoeuvrable under relatively small forces.

However, this maneuverability also provides a significant drawback in that the orientation of the castor wheels cannot be controlled other than by applying a force in a direction that you want the device to travel. If other forces, such as gravity for example, are being applied to the castor wheels, then these forces need to also be counteracted.

In this respect one common problem with using a shopping trolley is that when pushing the trolley, especially a full trolley, across a gradient the weight of the trolley applies a force of the trolley down the gradient, which the castors wheels will want to follow unless a counter force is applied. For a very full trolley, the up-hill counter force required can be quite large. In this situation pushing the trolley is awkward and difficult and there is a risk, when in a carpark, of hitting cars with the trolley. Furthermore, the trolley is very difficult to stop on a gradient without propping the trolley against a post or a car for example.

### SUMMARY OF THE DISCLOSURE

According to an embodiment of the present disclosure, there is provided a castor wheel assembly comprising:

a wheel having an axle about which the wheel is configured to rotate;

a mounting structure provided on the axle for mounting the castor wheel assembly to a body, the mounting structure defining a pivot axis perpendicular to the wheel axle about which the mounting structure is pivotable to rotate the orientation of the wheel with respect to the pivot axis; and

a locking mechanism operable to adopt a locking condition in which it locks the orientation of the wheel relative to the pivot axis or an unlocked condition in which the mounting structure is allowed to pivot the wheel around the pivot axis.

The mounting structure may comprise a pivot shaft that defines the pivot axis. The locking mechanism may be operable to prevent rotation of the shaft to lock the orientation of the wheel relative to the pivot axis.

The locking mechanism may comprise an engaging member, the locking mechanism being operable to bring the engaging member into engagement with the shaft to prevent rotation of the shaft.

The pivot shaft may comprise a cam portion for the engaging member to engage to prevent rotation of the shaft.

The engaging member may comprise a plate member having a non-circular aperture formed therein for engaging the shaft.

The aperture in the plate member may be generally ovoid in shape.

The assembly may comprise an operator for causing the locking mechanism to adopt its locking or unlocked conditions.

The operator may comprise an electromagnet.

The electromagnet may be disposed about the pivot shaft.

The electromagnet may be cylindrical.

The electromagnet may be operable to draw the engaging member towards the electromagnet.

The assembly may comprise a remote actuator for remotely operating the electromagnet.

The assembly may comprise a rechargeable battery for powering the electromagnet.

The assembly may be configured to recharge the battery by rotation of the mounting structure when the locking mechanism is in its unlocked condition.

According to another embodiment of the present disclosure, there is provided a shopping trolley having at least one castor wheel according to the embodiment described above.

The trolley may comprise a handle and an actuator mounted to the handle for a user to cause the locking mechanism of the at least one castor wheel to adopt its locking or unlocked condition.

### BRIEF DESCRIPTION OF THE DRAWINGS

Embodiments of the present disclosure will now be described, by way of example only, with reference to the accompanying drawings, in which:

FIG. 1 is a perspective view from below of a castor wheel assembly according to an embodiment of the present disclosure attached to a shopping trolley;

FIG. 2 is an exploded perspective view of the castor wheel assembly of FIG. 1, showing a locking mechanism of the castor wheel assembly in detail;

FIG. 3 is a side view of the castor wheel assembly of FIG. 1 with the locking mechanism in an unlocked condition;

FIG. 4 is a magnified view of part of FIG. 3;

FIG. 5 is a plan view of a plate member of the locking mechanism showing the ability of the pivot shaft of the castor wheel assembly to rotate when the locking mechanism is in its unlocked condition as in FIG. 3;

FIG. 6 is a side view of the castor wheel assembly of FIG. 1 with the locking mechanism in a locked condition;

FIG. 7 is a magnified view of part of FIG. 6; and

FIG. 8 is a plan view of the plate member of the locking mechanism locking the pivot shaft of the castor wheel assembly against rotation when the locking mechanism is in its locked condition as in FIG. 6.

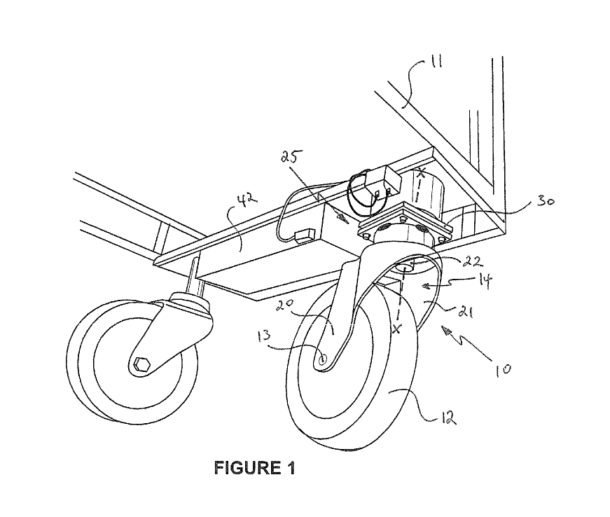

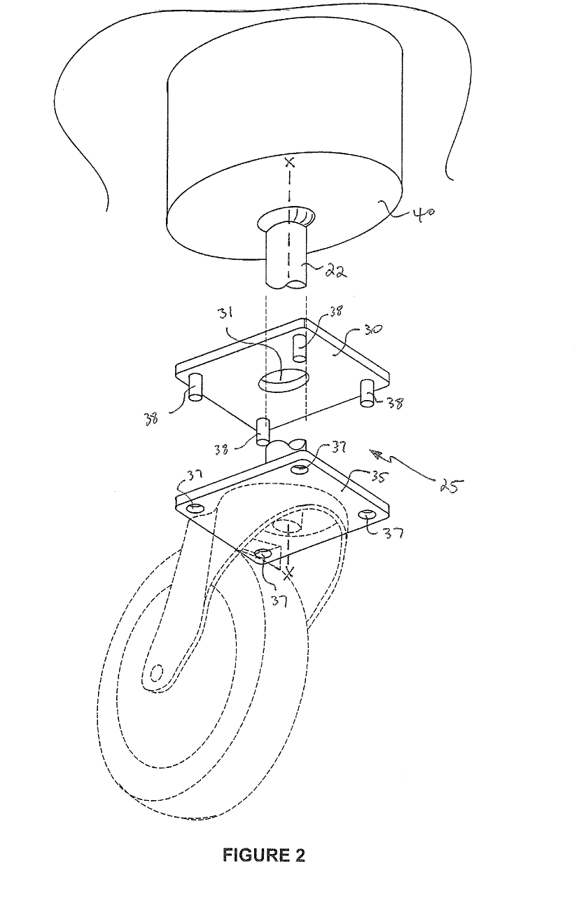

### DETAILED DESCRIPTION

Referring to the Figures, a castor wheel assembly 10 according to an embodiment of the present disclosure is shown. The castor wheel assembly 10 is shown mounted to the bottom of a shopping trolley 11. However, it is to be understood that the castor wheel assembly could be used with other apparatuses such as office chairs, a wheel chair trailer or even with a light plane as its tail wheel.

The castor wheel assembly 10 comprises a wheel 12 having an axle 13 about which the wheel rotates and a mounting structure 14 to mount the wheel 12 to the trolley 11 or other apparatus, vehicle or body. The mounting structure 14 comprises opposed arms 20, 21 that at one end couple to respective opposed ends of the wheel axle 13 and at the other end couple to a pivot shaft 22 of the mounting structure. The pivot shaft 22 defines a pivot axis X-X about which the mounting structure is pivotable to rotate the orientation of the wheel 12 with respect to the pivot axis. In other words, the pivot axis is offset from the wheel axle 13 so that as with any conventional castor wheel, the mounting structure 14 and hence the wheel 12 pivots about the pivot axis to align itself generally with the direction in which a force is applied to the wheel 12.

The castor wheel assembly 10 also comprises a locking mechanism 25 operable to lock the orientation of the wheel 12 relative to the pivot axis so that the wheel can no longer freely align itself with the direction in which a force is applied to the wheel 12. The locking mechanism 25 comprises an engaging member in the form of a plate 30 having an ovoid aperture 31 therethrough. To lock the wheel 12, the plate 30 engages the pivot shaft 22 by receiving a cam portion 32 of the shaft 22 in the plate's aperture 31. The cam portion 32 has an oval cross-section and as shown in FIGS. 7 and 8, when this is received in the ovoid aperture 31 of the plate 30, the shaft 22 and hence the wheel 12 is prevented from rotating about the pivot axis. However, when not so received, as shown in FIGS. 4 and 5, the shaft 22 and the wheel 12 are free to rotate about the pivot axis 12.

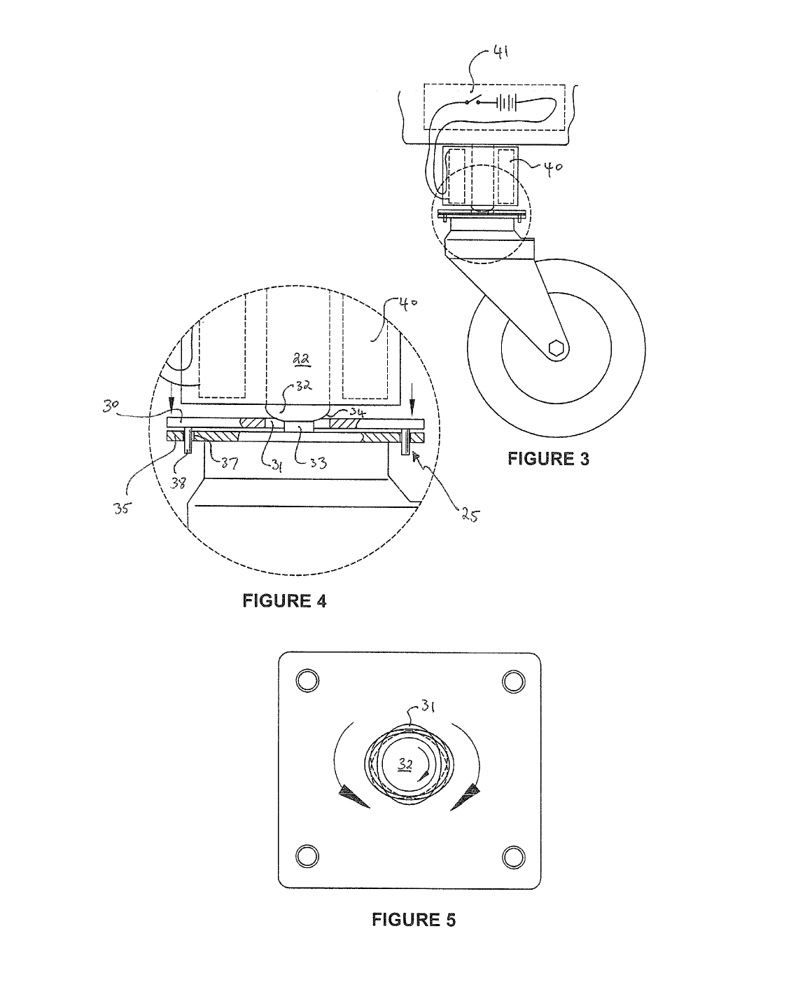

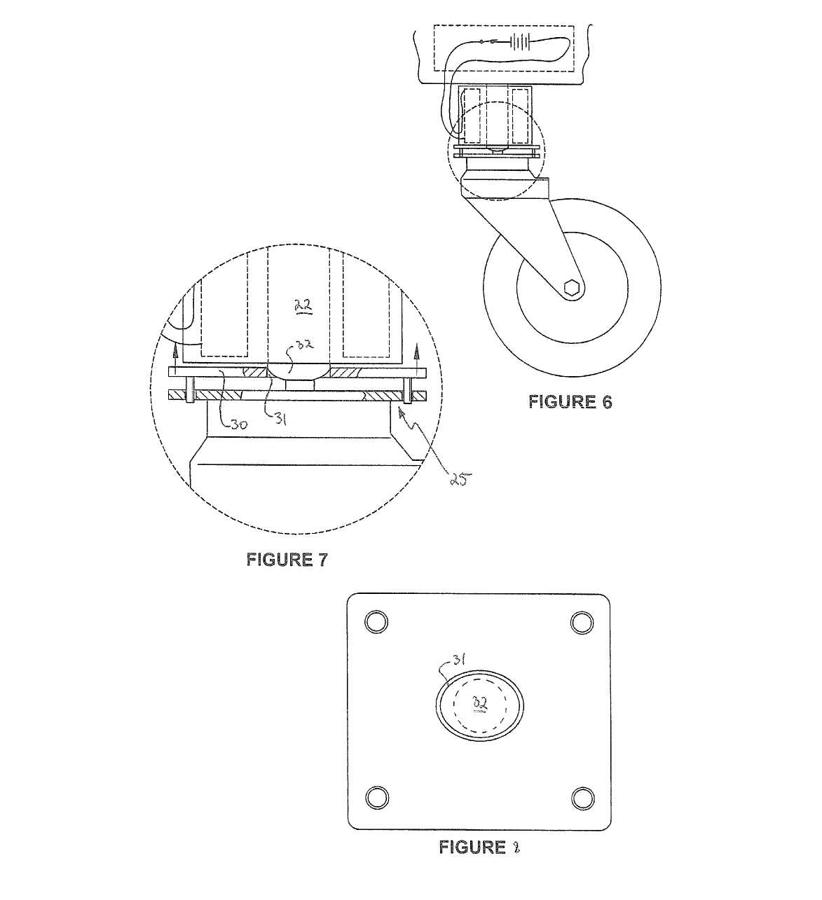

Advantageously, by using the locking mechanism 25 to lock the wheel 12 with respect to the pivot axis, the wheel is fixed in a particular orientation and movement of the apparatus to which the castor wheel assembly 10 is mounted can be more readily controlled because forces acting in directions transverse to the direction it is desired to move the apparatus cannot cause an undesirable alignment of the wheel. For example with the shopping trolley 11 shown in the Figures, when pushing the trolley across a sloped or angled surface, the locked wheel 12 prevents the trolley from turning with gravity down the angled surface. It is noted that the locking mechanism 25 is selectively operable so that it can adopt either a locked or an unlocked condition. This means that when moving the shopping trolley 11 for example across a flat surface, the locking mechanism 25 can be brought into its unlocked condition as shown in FIGS. 3-5 to enable the wheel to freely pivot about the pivot axis and thus enable the high maneuverability of the shopping trolley as would be provided by any conventional castor wheel assembly in these circumstances. For the shopping trolley 11 in particular, only one of the castor wheel assemblies need to incorporate the locking mechanism 25 as the other castor wheels of the trolley will be forced to align with the direction of movement dictated by the locked wheel 12.

With the locking mechanism 25 shown and described in relation to the Figures, the oval shape of the plate aperture 31 and the shaft cam portion 32 means that the wheel 12 can only be locked in one of two orientations at 180° to each other. Typically, the castor wheel assembly 10 would be mounted to the trolley 11 so that these orientations correspond to directly forward and reverse movement of the trolley when pushed or pulled from behind by a user. Because at the time of bringing the locking mechanism 25 into its locking condition the cam portion 32 and the plate aperture 31 may not be accurately aligned in one of the two orientations that the wheel 12 can be locked, the cam portion 32 defines a tapered surface portion 34 that slips against the surfaces of the plate define by the aperture 31 as the engaging member plate 30 is brought into engagement with the pivot shaft 22. This causes the pivot shaft 22 to rotate somewhat so that the plate aperture 31 and the cam portion 32 of the shaft 22 are brought into the required orientation for locking the wheel 12 with respect to the pivot axis.

However, in other embodiments, the locking mechanism may be designed so that orientation of the wheel is discretely variable about 360° about the pivot axis. For example, the cam portion of the shaft may be provided with one or more ridges and the aperture in the plate shaped with a plurality of grooves for receiving the ridge(s) to lock the wheel with respect to the pivot axis in one of a number of positions defined by the grooves. In further embodiments, the locking mechanism may be designed so that the orientation of the wheel is infinitely variable about 360° about the pivot axis. For example, the locking mechanism may comprise a clamp arm that engages the cam portion of the pivot shaft in any position.

Returning to the embodiment shown in the Figures, as can be seen by comparing FIGS. 4 and 7, to cause the locking mechanism to adopt its locking condition, the plate 30 is moved upwardly away from the wheel 12 to engage the pivot shaft's cam portion 32. When the locking mechanism is in its unlocked condition, the cam portion 32 is above the plate 30. The pivot shaft 22 itself narrows as it extends away from the cam portion towards the wheel so that this narrower portion 33 of the shaft 22 extends through the aperture 31 in the plate 30 to join to the mounting arms 20, 21 without engaging the plate when the locking mechanism 25 is in its unlocked condition. This enables the mounting structure 14 and hence the wheel 12 to freely pivot about the pivot axis in this condition.

The engaging member in the form of the plate 30 is mounted to a base member 35, that itself is mounted to the mounting structure 14 of the assembly 10. The base member 35 has a large central aperture 36 through which the pivot shaft 22 extends. The base member 35 is a generally square plate of similar dimensions to the engaging member. The base member 35 is provided with apertures 37 at each of its corners for receiving pins 38 extending from the engaging member plate 30. The pins 38 have a loose fit in the apertures 37 so as to allow the engaging member plate 30 to freely move up and down between locking and unlocked conditions of the locking mechanism 25, whilst keeping the plate 30 assembled with the castor wheel assembly 10 in its correct alignment with respect to the pivot shaft 22. It is to be understood that in a variation the pins could be provided on the base member and the pin receiving apertures in the engaging member plate. Further, although the particular embodiment in the Figures shows four pins, the assembly could comprise more or less pins (and corresponding apertures for receiving them).

For bringing the locking mechanism 25 into its locking condition, the castor wheel assembly 10 also comprises an operator in the form of an electromagnet 40. The electromagnet acts to bring the engaging member plate 30 into engagement with the cam portion 32 of the pivot shaft 22 by drawing the plate 30 towards the electromagnet 40. As with any conventional electromagnet, the electromagnet 40 comprises a coil of insulated wire wrapped around an iron core, the wires connected to a power source. The iron core of the electromagnet is cylindrical and is positioned around the pivot shaft 22 above the cam portion 32 and above the plate 30. A switch 41 is provided to turn the electromagnet 40 on and off to selectively operate the locking mechanism 25 to adopt is locking or unlocked condition. As shown in FIGS. 6-8, when the electromagnet 40 is switched on using the switch 41, it draws the plate 30 upward to engage the cam portion 32 of the pivot shaft and thereby locking the orientation of the wheel 12 with respect to the pivot axis. Referring to FIGS. 3-5, when the electromagnet is switched off the plate 30 drops away from the cam portion 32 under gravity. This disengagement of the plate 30 from the cam portion 32 allows the wheel 12 to freely pivot with respect to the pivot axis.

The electromagnet 40 is powered by a rechargeable battery 42. When the locking mechanism 25 is in its unlocked condition and the wheel 12 and the pivot shaft 22 are free to pivot about the pivot axis, the electromagnet 40 and the shaft 22 are configured so that rotation of the portion of the pivot shaft 22 within the electromagnet generates a current within the electromagnet's wire coil which charges the battery. Advantageously, this means that the lifetime of the battery is significantly increased.

Switching the electromagnet on and off is remotely operated by an actuator such as a push button or switch located on a handle of the shopping trolley 11. This provides ease of use for the user of the trolley. The actuator may be physically wired to the electromagnet or alternatively may signal the electromagnet using radio or infra-red (IR) waves.

Although the embodiment shown in the Figures uses an electromagnet, other operators for bringing the engaging member or some other kind of locking portion into engagement with the pivot shaft to lock the wheel in its orientation with respect to the pivot axis are contemplated. For example a mechanical means may be provided such as a threaded member coupled to the engaging member which when turned causes the engaging member to come into engagement with the pivot shaft. Another mechanical means may comprise a lever member that when operated levers the engaging member into engagement with the pivot shaft. In another embodiment, the operator may comprise hydraulic brake means or brake callipers to prevent rotation of the pivot shaft and thus lock the orientation of the wheel with respect to the pivot axis.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

1. A castor wheel assembly comprising:
a wheel having an axle about which the wheel is configured to rotate;
a mounting structure provided on the axle for mounting the castor wheel assembly to a body, the mounting structure defining a pivot axis perpendicular to the wheel axle about which the mounting structure is pivotable to rotate the orientation of the wheel with respect to the pivot axis; and
a locking mechanism operable to adopt a locking condition in which it locks the orientation of the wheel relative to the pivot axis or an unlocked condition in which the mounting structure is allowed to pivot the wheel around the pivot axis.

2. The castor wheel assembly as claimed in claim 1, wherein the mounting structure comprises a pivot shaft that defines the pivot axis and the locking mechanism is operable to prevent rotation of the shaft to lock the orientation of the wheel relative to the pivot axis.

3. The castor wheel assembly as claimed in claim 2, wherein the locking mechanism comprises an engaging member, the locking mechanism being operable to bring the engaging member into engagement with the shaft to prevent rotation of the shaft.

4. The castor wheel assembly as claimed in claim 3, wherein the pivot shaft comprises a cam portion for the engaging member to engage to prevent rotation of the shaft.

5. The castor wheel assembly as claimed in claim 3 wherein the engaging member comprises a plate member having a non-circular aperture formed therein for engaging the shaft.

6. The castor wheel assembly as claimed in claim 5, wherein the aperture in the plate member is generally ovoid in shape.

7. The castor wheel assembly as claimed in claim 1, the assembly comprising an operator for causing the locking mechanism to adopt its locking or unlocked conditions.

8. The castor wheel assembly as claimed in claim 7, wherein the operator comprises an electromagnet.

9. The castor wheel assembly as claimed in claim 8 wherein the mounting structure comprises a pivot shaft that defines the pivot axis and the locking mechanism is operable to prevent rotation of the shaft to lock the orientation of the wheel relative to the pivot axis, and the electromagnet is disposed about the pivot shaft.

10. The castor wheel assembly as claimed in claim 8, wherein the electromagnet is cylindrical.

11. The castor wheel assembly as claimed in claim 8 wherein the locking mechanism comprises an engaging member, the locking mechanism being operable to bring the engaging member into engagement with the shaft to prevent rotation of the shaft and the electromagnet is operable to draw the engaging member towards the electromagnet.

12. The castor wheel assembly as claimed in claim 8, wherein the assembly comprises a remote actuator for remotely operating the electromagnet.

13. The castor wheel assembly as claimed in claim 8, wherein the assembly comprises a rechargeable battery for powering the electromagnet.

14. The castor wheel assembly as claimed in claim 13, wherein the assembly is configured to recharge the battery by rotation of the mounting structure when the locking mechanism is in its unlocked condition.

15. A shopping trolley having at least one castor wheel according to claim 1.

16. The shopping trolley as claimed in claim 15, wherein the trolley comprises a handle and an actuator mounted to the handle for a user to cause the locking mechanism of the at least one castor wheel to adopt its locking or unlocked condition.
